(19) United States
(12) Patent Application Publication
(10) Pub. No.: US 2020/0130685 A1
(43) Pub. Date: Apr. 30, 2020

(54) APPARATUS AND METHOD FOR IDENTIFYING SENSOR OCCLUSION IN AUTONOMOUS VEHICLES

(71) Applicants: DENSO International America, Inc., Southfield, MI (US); Denso Corporation, Kariya (JP)

(72) Inventors: Trong Duy NGUYEN, Novi, MI (US); Hiroshi INO, West Bloomfield, MI (US)

(21) Appl. No.: 16/175,083

(22) Filed: Oct. 30, 2018

(51) Int. Cl. B60W 30/10; G05D 1/00

(52) U.S. Cl. CPC B60W 30/10; G05D 1/0246; G05D 1/0088

(57) ABSTRACT

A driving system for a first vehicle comprises a first and second sensor configured to obtain proximity data for one or more vehicles proximate the first vehicle, and a processor in communication with the first and second sensors and programmed to perform the functions of identifying a plurality of vehicles in a first field-of-view instance based on the proximity data, wherein the plurality of vehicles in the first field-of-view has a trajectory to approach a second field-of-view instance based on the proximity data, and adjusting a vehicle maneuver in response to one of the plurality of vehicles being absent from the second field-of-view instance.

### TECHNICAL FIELD

The present disclosure relates to vehicles, and in particular, autonomous vehicles.

### BACKGROUND

An autonomous vehicle may include multiple types of sensors, such as LIDARs, radars, cameras, GPS, map, etc. The sensors may be installed on the vehicle to provide 360 degrees of field of view (FOV) and perception around a vehicles' driving environment. In most situations, 360 degrees FOV set of sensors can supply enough information and knowledge about the driving environment to autonomous vehicles (e.g. ego vehicle). But in a situation where occlusions of sensors, information provided by the sensors are blocked, hence the ego vehicle may not have enough information or the incorrect information about its driving environment. In such a case, an ego vehicle can make an improper action which may result in improper maneuvering or perhaps an accident.

### SUMMARY

According to one embodiment, a driving system for a first vehicle comprises a first and second sensor configured to obtain proximity data for one or more vehicles proximate the first vehicle, and a processor in communication with the first and second sensors and programmed to perform the functions of identifying a plurality of vehicles in a first field-of-view instance based on the proximity data, wherein the plurality of vehicles in the first field-of-view has a trajectory to approach a second field-of-view instance based on the proximity data, and adjusting a vehicle maneuver in response to one of the plurality of vehicles being absent from the second field-of-view instance.

According to a second embodiment, a driving system for a first vehicle includes one or more sensors configured to obtain proximity data for one or more vehicles proximate the first vehicle, and a processor in communication with the one or more sensors and programmed to identify, using the proximity data, one or more vehicles approaching an area-of-intersection defined by at least a trajectory of the first vehicle and trajectory of the one or more vehicles, compare a number of identified vehicles that enter the area-of-intersection to the number of identified vehicles that exit the area-of-intersection, and adjust a driver assistance function in response to the comparison identifying less identified vehicles that exit the area-of-intersection.

According to a third embodiment, a method implemented in an autonomous vehicle comprises obtaining proximity data for one or more vehicles proximate the autonomous vehicle utilizing a first and second sensor, identifying a plurality of vehicles in a first field-of-view of a first sensor utilizing the proximity data, wherein the plurality of vehicles in the first field-of-view have a trajectory to enter a second field-of-view of the second sensor, determining that one of the plurality of vehicles did not enter the second field-of-view, and maneuvering the autonomous vehicle in response to the determination.

### BRIEF DESCRIPTION OF THE DRAWINGS

FIG. 1 illustrates a system 10 for implementing an autonomous driving system configured to generate a driving plan for an autonomous vehicle.

FIG. 2 illustrates an example flowchart of identifying an object through sensor occlusion.

FIG. 3 illustrates an example flow chart of maneuvering in view of possible sensor occlusion.

FIG. 4A illustrates an example of an autonomous vehicle with no sensor occlusion.

FIG. 4B illustrates an example of an autonomous vehicle with sensor occlusion.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

An autonomous driving system of a vehicle may be configured to control the vehicle by predicting the future behaviors of objects, such as other vehicles, proximate to the vehicle being controlled. For such a system to perform well, these predictions need to be accurate and account for all surrounding dynamic objects (e.g. objects that move). In some cases, the autonomous vehicle driving system may be configured to predict the future behavior of a proximate object by applying current observations of the proximate object to a trained behavior model built from a large data set of previous object behavior. This approach may be referred to herein as a learning-based approach. While the learning-based approach may perform well under normal driving conditions, this approach can fail when the autonomous vehicle driving system is confronted with a situation not well-represented by the trained behavior model. For example, if the autonomous vehicle driving system confronts an anomalous driving situation, such an oncoming vehicle disappearing after being detected due to blockage from a vehicle's sensor, the prediction model may not accurately reflect vehicle behavior for the situation or have to correct maneuvering that was initially planned. Consequently, the if the predicational model does not account for the missing object, may cause the autonomous vehicle driving system to act in accordance with a poor or inaccurate prediction, which may result in risky on-road circumstances.

Thus, in addition or alternatively to implementing the learning-based approach, the autonomous vehicle driving system may also be configured to implement a planning-based approach for proximate objects when it encounters “missing” objects proximate the vehicle. Specifically, rather than simply applying observations of a proximate object to a trained behavior model and receiving a prediction, the autonomous vehicle driving system may be configured to generate a driving plan for the missing object and adjust maneuvering in situations where the blocked objected may reappear. If that object disappears or is blocked from a host vehicle's sensor, the host vehicle may adjust if the prediction model predicts that the vehicle is there but blocked by an object.

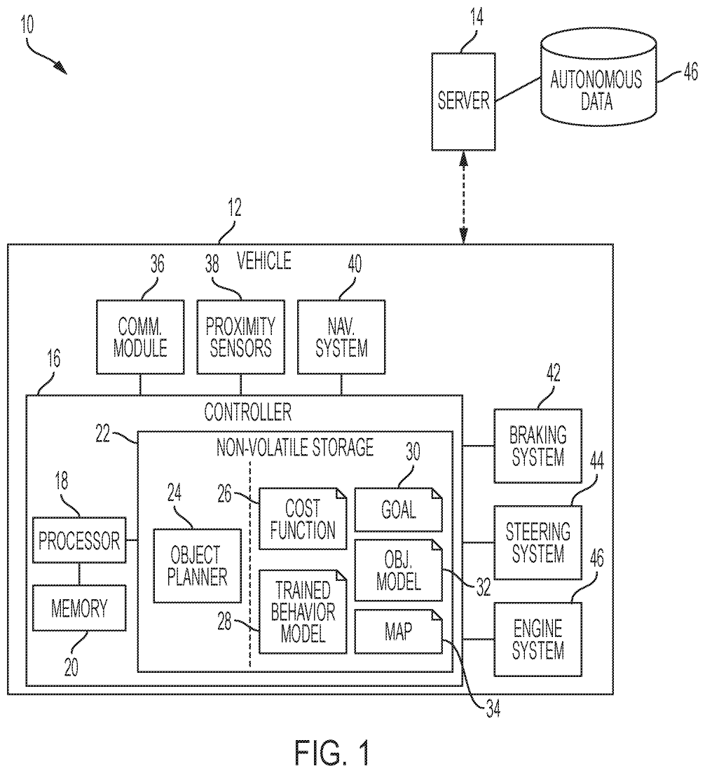

FIG. 1 illustrates a system 10 for implementing an autonomous driving system configured to generate a driving plan for an autonomous vehicle. The system 10 may include an autonomous vehicle 12 and a remote server 14. The vehicle 12 may wirelessly communicate with the remote server 14 via one or more networks, such as one or more of the Internet, a local area network, a wide area network, and a cellular network.

The vehicle 12 may include a controller 16. The controller 16 may be a vehicle controller, such as an electronic control unit (“ECU”). The controller 16 may be configured to implement the planning-based approach and/or the learning-based approach described herein. In other words, the controller 16 may be configured to plan the operation of other vehicles traveling proximate the vehicle 12, and to control the vehicle 12 based thereon.

The controller 16 may include a processor 18, memory 20, and non-volatile storage 22. The processor 18 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 20. The memory 20 may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage 22 may include one or more persistent data storage devices such as a hard drive, optical drive, tape drive, non-volatile solid-state device, or any other device capable of persistently storing information.

The processor 18 may be configured to read into memory 20 and execute computer-executable instructions embodying one or more software programs, such as an object planner 24, residing in the non-volatile storage 22. The object planner 24 may be part of an operating system or an application, and may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/SQL. The computer-executable instructions of the object planner 24 may be configured, upon execution by the processor 18, to cause the controller 16 to implement the object planner 24, and correspondingly to implement functions, features, and processes of the object planner 24 described herein.

The non-volatile storage 22 may also include data utilized by the controller 16, or more particularly by the object planner 24, when implementing the functions, features, and processes of the controller 16 described herein. For example, the non-volatile storage 22 may include cost function data 26, trained behavior model data 28, goal data 30, object model data 32, and map data 34, each of which may enable the object planner 24 to predict behaviors of other objects proximate the vehicle 12. The cost function data 26 may define one or more cost functions, each which may map a candidate trajectory for a proximate object to a cost value to the object for taking the trajectory. The trained behavior model data 28 may define one or more trained behavior models, each which may be configured to predict the future behavior of a given proximate object based on a data set of previously observed object behaviors and current observations of the proximate object. The goal data 30 may define goals for various objects given a particular travel context (e.g., highway road, city road, object class such as passenger vehicle, motorcycle, semi-truck, bicycle, pedestrian, or non-moving object in the road). The object model data 32 may define one or more object models, which may set forth the dynamics for various object classes. The map data 34 may define travel infrastructure details by location.

The non-volatile storage 22 may also include one or more database structures for collecting, organizing, and enabling fast retrieval of the data stored therein. For example, the stored data may be arranged in one or more relational databases, one or more hierarchical databases, one or more network databases, or combinations thereof. A database management system in the form of computer software executing as instructions on the processor 18 may be used to access the information or data records of the databases in response to a query, which may be dynamically determined and executed by the object planner 24.

The controller 16 may communicate with other components of the vehicle 12, such as a communications module 36, various proximity sensors 38, a navigation system 40, a braking system 42, a steering system 44, and an engine system 46. The controller 16 may be directly connected to one or more of these other components, such as via various input/output (I/O) ports of the controller 16. Additionally, or alternatively, the controller 16 may communicate with one or more of these other components over one or more in-vehicle networks, such as a vehicle controller area network (CAN), an Ethernet network, a media oriented system transfer (MOST) network, and a wireless local area network (WLAN).

The communications module 36 may be configured to facilitate wireless communication between the vehicle 12 components and other devices and systems external to the vehicle 12, such as the remote server 14, using radio frequency (RF) transmissions. For example, the communications module 36 may include a cellular modem or other wireless network transceiver (e.g., Wi-Fi transceiver) configured to communicate with the remote server 14 over one or more networks, such as one or more of the Internet, a local area network, a wide area network, and a cellular network to which the cellular modem is subscribed. The controller 16 may communicate with the remote server 14 by accessing the communication capabilities of the communications module 36.

The communications module 36 may also include one or more wireless transceivers configured to facilitate direct wireless communication with other devices and systems, such as a personal computer device or key fob, when such other devices and systems are local to (e.g., within direct wireless communication range of) the vehicle 12. To facilitate such local wireless communications, the communications module 36 may include a Bluetooth transceiver, a ZigBee transceiver, a Wi-Fi transceiver, a radio-frequency identification (“RFID”) transceiver, a near-field communication (“NFC”) transceiver, a vehicle-to-vehicle (V2V) transceiver, a vehicle-to-infrastructure (V2I) transceiver, and/or transceivers designed for other RF protocols particular to remote services provided by the vehicle 12 (e.g., keyless entry, remote start, passive entry passive start).

The proximity sensors 38 may be configured to detect objects proximate to the vehicle 12, and to correspondingly generate proximity data indicative of the current operating state of such objects. For example, the proximity sensors 38 may be configured to detect the existence of other vehicles, lane lines, guard rails, objects in the roadway, buildings, and pedestrians within a particular distance of the vehicle 12. The proximity sensors 38 may be configured to communicate the generated proximity data to the to the controller 16, which may be configured to interpret the proximity data to derive the operating state of each detected proximate object. For example, the controller 16 may be configured to identify a pose for each proximate object, which may indicate the position and orientation of each object relative to the vehicle 12 (e.g., angle and distance). The controller 16 may also be configured to identify movement information for each proximate object (e.g., speed, velocity, acceleration), and a class for each proximate object (e.g., passenger vehicle, truck, motorcycle, pedestrian, bicycle). The controller 16 may then be configured to utilize the operating state of each proximate object to plan an operation for the object, such as slowing down or switching lanes, and to control operation of the vehicle 12 based on the planned operation.

As an example, the proximity sensors 38 may include one or more LIDAR sensors. The LIDAR sensors may each be configured to measure a distance to an object external and proximate to the vehicle 12 by illuminating the target with a pulsed laser light and measuring the reflected pulses with a sensor. The LIDAR sensors may then measure the differences in laser return times and, based on these measured differences and the received wavelengths, may generate a digital 3-D representation of the object. The LIDAR sensors may further have the ability to classify various objects based on the 3-D rendering of the object. For example, by determining a shape of the target, the LIDAR sensors may classify the object as a passenger vehicle, motorcycle, truck, curb, roadblock, building, pedestrian, and so on. The LIDAR sensors may work in conjunction with other vehicle components, such as the controller 16 and other proximity sensors 38, to classify various objects outside of the vehicle 12. The LIDAR sensors may include laser emitters, laser receivers, and any other suitable LIDAR autonomous vehicle sensor components. The LIDAR sensors may further be arranged within a housing configured to rotate to facilitate scanning of the environment.

As another example, the proximity sensors 38 may include one or more cameras for capturing images of the environment surrounding the vehicle 12. For example, the proximity sensors 38 may include a forward-facing camera that is mounted to the rear-view mirror of the vehicle 12 and is configured to collect image data of the environment in front of the vehicle 12. Similarly, the proximity sensors 38 may include a rear-facing camera that is mounted to the trunk of the vehicle 12 and is configured to collect image data of the environment behind the vehicle 12, and may include side-facing cameras that are mounted to the side view mirrors of the vehicle 12 and are configured to collected image data of the environment to each side of the vehicle 12. The controller 16 may be configured to process the image data captured by the one or more cameras of the vehicle 12 to identify conditions around the vehicle 12, including, for example, the position of lane markers, the existence of traffic symbols, and the existence and operating state of other objects proximate the vehicle 12. The controller 16 may be configured to identify such conditions by comparing the location and color of pixels within the image data to prestored templates associated with various conditions.

As additional examples, the proximity sensors 38 may include one or more radar sensors, one or more ultrasonic sensors, and/or any other sensors for detecting information about the surroundings of the vehicle 12. The sensors may be mounted anywhere on the vehicle. For example, a proximity sensor 38 may be mounted on a roof of the vehicle 12 so as to have a three hundred sixty-degree view of the environment surrounding of the vehicle 12. Additionally, or alternatively, various proximity sensors 38 may surround the vehicle 12 to provide a three hundred sixty-degree view of the vehicle 12. The vehicle 12 may include actuators for adjusting an angle of the field of view of the various proximity sensors 38.

The navigation system 40 may be configured to generate geographic data for the vehicle 12, such as via communicating with one or more satellites orbiting Earth. The geographic data may indicate a current geographic location of the vehicle 12, such as by including current longitude and latitude coordinates of the vehicle 12. As some non-limiting examples, the navigation system 40 may include one or more of a Global Positioning System (GPS) module, a Quazi-Zenith Satellite System (QZSS) module, a Russian Global Navigation Satellite System (GLONASS) module, a Galileo System (GSNN) module, an Indian Regional Navigation Satellite System (IRNSS) module, and an inertial navigation system (INS) module.

The navigation system 40 may communicate the geographic data to the controller 16, which may be configured to utilize the geographic data to determine the geographic location of the vehicle 12, and to correspondingly determine the geographic location of detected proximate objects. The vehicle 12 may also include a gyroscope or compass configured to indicate a current heading of the vehicle 12, which the controller 16 may combine with the geographic data to produce data indicating the current location and heading of the vehicle 12. Alternatively, the controller 16 may determine the heading of the vehicle 12 based on received geographic data indicating a changed position of the vehicle 12 over a short time span (e.g., one second), which suggests that the vehicle 12 is moving in a direction corresponding to the change in position.

The controller 16 may be configured to query the map data 34 based on the geographic data to identify information about the travel infrastructure currently in use by the vehicle 12. In particular, the map data 34 may include detailed information about travel infrastructure in various geographic locations, such as road type (e.g., highway, city), road properties (e.g., one way, multi-lane, slope information, curvature information), detailed lane information (e.g., location, dimensions, restrictions such as no passing, turn-only, and traffic direction), and the locations and dimensions of curbs, sidewalks, traffic signals, traffic signs, and crosswalks relative to a road, as some non-limiting examples. Alternatively, the controller 16 may be configured to derive at least some of this information from proximity data generated by the proximity sensors 38, such as via processing image data captured by cameras of the vehicle 12.

Responsive to receiving the geographic data from navigation system 40, the proximity data from the proximity sensors 38, and the map data 34 corresponding to the received geographic data, the controller 16 may identify the position of each detected proximate object within the currently used travel infrastructure, which may also be part of the determined operating state for each object. Specifically, the controller 16 may be configured to determine the location of the vehicle 12 within travel infrastructure based on the geographic data, the map data 34, and/or the received proximity data, including which lane of the travel infrastructure the vehicle 12 is currently located. The controller 16 may then be configured to identify the location of each detected proximate object within the currently used travel infrastructure based on the relative position of each proximate object, as indicated in the proximity data, and the map data 34. For example, if the detailed lane information included in the map data 34, or the proximity data, indicates that a particular lane is located a given distance away from the current position of the vehicle 12, and the proximity data indicates that a detected proximate object is located alongside the vehicle 12 at a distance from the vehicle 12 equal to the given distance, then the controller 16 may be configured to determine that the proximate vehicle is traveling in the given lane.

The braking system 42, steering system 44, and engine system 46 may control movement of the vehicle 12, such as at the direction of the controller 16. In particular, the controller 16 may be configured to plan an operation for each detected proximate object based on the determined operating state for each object, and may then be configured to generate a driving plan for the vehicle 12 that avoids a collision with any of the detected proximate objects assuming they act according to the planned operations. Thereafter, the controller 16 may be configured to cause the vehicle 12 to operate according to the driving plan by transmitting corresponding control signals to the braking system 42, the steering system 44, and the engine system 46. For example, the controller 16 may transmit a control signal to the braking system 42 to slow down or stop the vehicle 12, may transmit a control signal to the steering system 44 to turn or adjust a heading of the vehicle 12, and may transmit a control signal to the engine system 46 to speed up the vehicle 12 to a specified velocity, to maintain a specified velocity, and to shift gears, in accordance with the driving plan.

The remote server 14 may similar include a processor, memory, and non-volatile storage including data and software that, upon execution by the processor of the remote server 14, causes the remote server 14 to perform the functions, features, and processes of the remote server 14 discussed herein. The remote server 14 may have access to one or more autonomous databases 48, which may be maintained in the non-volatile storage of the remote server 14 or in an external persistent storage device accessible by the remote server 14, such as a network drive. The autonomous databases 48 may include up-to-date versions of the data stored in the non-volatile storage 22 of the controller 16, such as the cost function data 26, map data 34, and so on. Periodically, the controller 16 may be configured to query the remote server 14 via the communications module 36 to determine if its data is up to date. If not, the remote server 14 may be configured to transmit the up-to-date data to the vehicle 12 for inclusion in the non-volatile storage 22. Alternatively, responsive to an update to the autonomous databases 48 that is relevant to the vehicle 12, the remote server 14 may be configured to transmit the updated data to the vehicle 12.

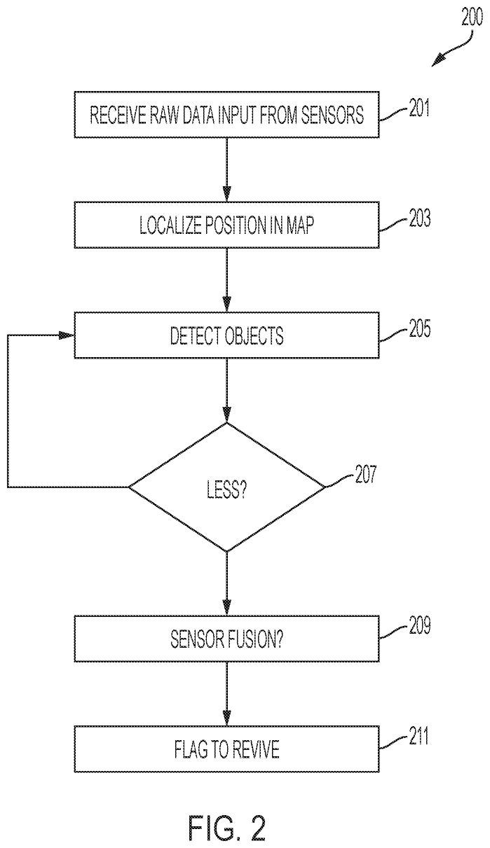

FIG. 2 illustrates an example flowchart 200 of identifying an object through sensor occlusion. The flow chart 200 may be implemented on an autonomous vehicle controller or off-board server in communication with an autonomous vehicle. At step 201, the autonomous vehicle may receive raw data input from various type of sensors in the vehicle. Such data may include data regarding the host vehicle (e.g. autonomous vehicle) and data regarding the host vehicle's surrounding. For example, the autonomous vehicle may collect information regarding the host vehicle's speed (e.g. vehicle speed), trajectory, upcoming maneuvering, navigation destination schedule, yaw rate, GPS location, etc. The data regarding the environment may include the identification of objects (e.g. vehicles, signs, etc.), trajectory of moving objects, identification of vehicle type, etc. Such data may be gathered from sensors mounted on the outside of the vehicle or on-board servers.

At step 203, the host vehicle may then localize its position on the map. For example, the host vehicle may identify the position (e.g. the (x,y) position of the vehicle on the map) of the host vehicle. Thus, it may identify where the vehicle is in relationship to the maneuver and other objects around it. For example, the host vehicle may identify a location utilizing GPS data and then identity its position utilizing map data. The vehicle system may also then identify how far each object is from the host vehicle and identify a trajectory for those objects if they are moving.

At step 205, the host vehicle may then detect the number of objects in its surrounding area. The host vehicle may be equipped with various sensors utilized to identify the vehicles and track the number of objects identified. The number of objects may be stored in memory and tracked to identify critical vehicles that are projected to go in the vehicle's path. The vehicle system may continually track the objects in the vehicle's vicinity that may be later compared, as explained below. For example, the vehicle sensors may identify approximately six surrounding vehicles in an instance (e.g. three vehicles in front of the host vehicle and three vehicles behind the host vehicle).

At step 207, the vehicle may continuously compare the number of objects within the vehicle's proximate vicinity. For example, the vehicle may identify the number of objects detected at step 205 and continuously compare the objects that were detected. If the vehicle knows that the objects left the vehicle path, it can be assumed that the moving object either is being blocked from being detected or left the area of detection for the vehicle. The host vehicle may identify the objects nearby and plan the moving vehicle's trajectory. A host vehicle may have a surrounding environment that is the sphere area with 360 deg field of view, or another degree that is based upon the range of installed sensors on the host/ego vehicle. For example, at a cross-intersection, traffic may include bicycles, pedestrians, cars, trucks, animals, etc., that are traveling from a North to South direction and from an East to West direction. If the objects are in the range of sensors, the host vehicle will count the objects going to the area within a sensor's field of view and going out of the area within a sensor's field of view.

At step 209, the vehicle system may utilize sensor fusion to predict the trajectory of the moving objects. The moving objects trajectory may be utilized to identify a “conflict area,” or an area where the moving object and the host vehicle may meet in the future based on the host vehicle's planned path. A sensor fusion and localization module may receive inputs from the various types of sensors in the vehicle, such as cameras, LIDARs, radars, GPS, maps, etc. The sensor fusion module may process and output the localization information of the ego/host vehicle in the map and output sensor fusion data to the ego vehicle. The sensor fusion module may be able to detect, track, and calculate the number of objects in the conflict area or an area of interest (AOI). If the number of dynamic objects that go into the AOI are not equal to those going out of the AOI, a flag may be set to update motion predication of moving objects and at the same time to inform a path planner module of the ego vehicle. The change in prediction horizon versus intermittent object detection may help to achieve maneuvering during sensor occlusion.

A sensor fusion and localization module may receive inputs from various types of sensors (e.g. cameras, LIDARs, radars, GPS, amps, etc.). A sensor fusion and localization module may process and output the localization information of the ego/host vehicle in the map and also output such sensor fusion data to the ego vehicle. Within a range of the sensors, the sensor fusion and localization module may be able to detect, track, and calculate the number of objects in an area-of-interest or area-of-intersection (AOI). The AOI (also called conflict area) may be may be defined as an area or intersection where the surrounding dynamic objects and the ego/host vehicle path intersect. The AOI may have a buffer zone that is utilized that surrounds a point of intersection between the ego vehicle and the moving vehicle's intersection. For example, a 10-foot radius or diameter buffer from each point of possible intersection between the ego vehicle and traveling vehicles may be utilized to create the AOI. If the number of dynamic objects that go into or enter the AOI are not equal to those exiting or going out of the AOI, a flag is set to update motion prediction of moving objects and at the same time to inform a path planner module. Surrounding dynamic objects may be predicted in terms of lateral motion (e.g. turn left or go straight) and in terms of longitudinal motion (e.g. yield or pass). A path planner module may use input from the sensor fusion and localization module to define an intersecting area (e.g. AOI) and decide to either: (1) delay a maneuver (e.g. wait and then go); or (2) go before the oncoming vehicles enter a conflict area. Thus, when the host vehicle is experiencing sensor occlusion, the path planner and motion controller may calculate a proper trajectory and lateral and longitudinal commands to improve sensor visions.

In another example, the host vehicle may experience or determine that sensor occlusion is taking place. The path planner and motion controller can also change its position in the left/right direction or forward/backward direction (accounting for a locations traffic regulations) to have improved sensor vision until sensor occlusion is cleared as confirmed by the sensor fusion module. For example, the host vehicle may determine that sensor occlusion has taken place, and movement of the vehicle to the left or right may improve the sensors vision. The host vehicle may utilize a planned trajectory of the dynamic objects to calculate which area for the vehicle to move to identify objects or vehicles that may be blocked via sensor occlusion The host vehicle may move its position until it has identified the missing objects (e.g. the number of objects that entered a zone is equal to those that exited or the number of objects expected to enter a zone have entered the zone).

At step 211, the vehicle system may flag the confidence. The flag may be set to identify a sensor occlusion by identifying a missing object. Thus, if the flag is set could identify a potential risk of sensor occlusion, which is later utilized in the motion controller to account for such occlusion. The sensor fusion modules or prediction modules may update maneuvering if the flag is set or may ignore it if the flag is not set. Additionally, the upcoming maneuver may be delayed or may be executed faster based on the sensor occlusion, or the maneuver may be cancelled.

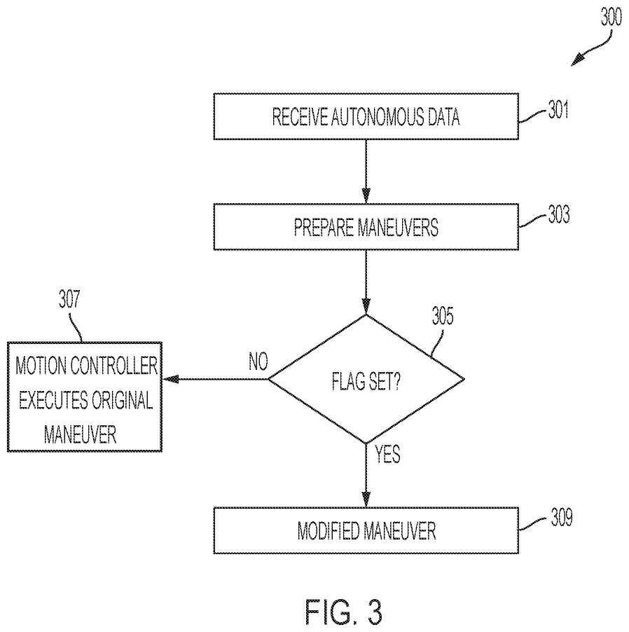

FIG. 3 illustrates an example flow chart 300 of maneuvering in view of sensor occlusion. The flow chart 300 may be implemented into a controller of an autonomous vehicle. A controller may receive autonomous data 301 that relates to the maneuvering of the autonomous vehicle. For example, the autonomous data may include position data of the vehicle (e.g. x,y data), speeds of the vehicle (both lateral speed and forward speed), acceleration of the vehicle (e.g. both lateral acceleration and forward acceleration), object type of surrounding objects (e.g. surrounding vehicles, street signs, pedestrians, bicycles, etc.), as well as situation judgment flags (e.g. sensor occlusion flag).

At step 303, the vehicle controller may prepare and plan for an upcoming maneuver. The upcoming maneuver may be utilized by planning the vehicle's trajectory with surrounding objects trajectory that surround the vehicle. For example, the vehicle may be planning a left maneuver in a certain time period based on the vehicle's surrounding environment and the navigation route.

At step 305, the vehicle controller may determine if a flag is set to adjust the maneuvering. In one example, the flag may be set that identifies sensor occlusion based on failure of object detection in the vehicle's 360 FOV. When a flag is set the vehicle controller may execute a certain path of commands that are not, as explained in step 307. However, when a flag is not set, the vehicle controller may execute another set of commands.

At step 307, the vehicle's controller (e.g. motion controller) may execute the command as originally planned given that the flag is not set. The motion controller may utilize various vehicle parameters to execute the command/maneuver, including the gear, steering angles (e.g. front steering angle, and rear steering angle), velocity, acceleration, mass, load, etc. For example, when no flag is set and no sensor occlusion is identified, the vehicle may thus determine that a left turn is appropriate and execute the maneuver as planned. In contrast and as explained in more detail below, an identification of sensor occlusion may adjust the planned maneuvering for an autonomous vehicle.

At step 309, the vehicle's controller (e.g. motion controller) may execute the command in response to the flag being set. The motion controller may utilize various vehicle parameters to execute the command/maneuver, including the gear, steering angles (e.g. front steering angle, and rear steering angle), velocity, acceleration, mass, load, etc. The motion controller may decide to either: (1) delay a maneuver (e.g. wait and then go); (2) go before the oncoming vehicles enter into a conflict area; (3) abort a maneuver; or (4) adjust a maneuver (e.g. move the ego vehicle in a different direction than originally planned). The host vehicle may also calculate a proper trajectory and lateral and longitudinal commands to improve sensor visions. Thus, the host vehicle may change its position in the left/right direction or forward/backward direction (accounting for a locations traffic regulations) to have improved sensor vision until sensor occlusion is cleared as confirmed by the sensor fusion module. For example, the host vehicle may determine that sensor occlusion has taken place, and movement of the vehicle to the left or right may improve the sensors vision. The host vehicle may utilize a planned trajectory of the dynamic objects to calculate which area to move to. The host vehicle may move its position until it has identified the missing objects (e.g. the number of objects that entered a zone is equal to those that exited or the number of objects expected to enter a zone have entered the zone).

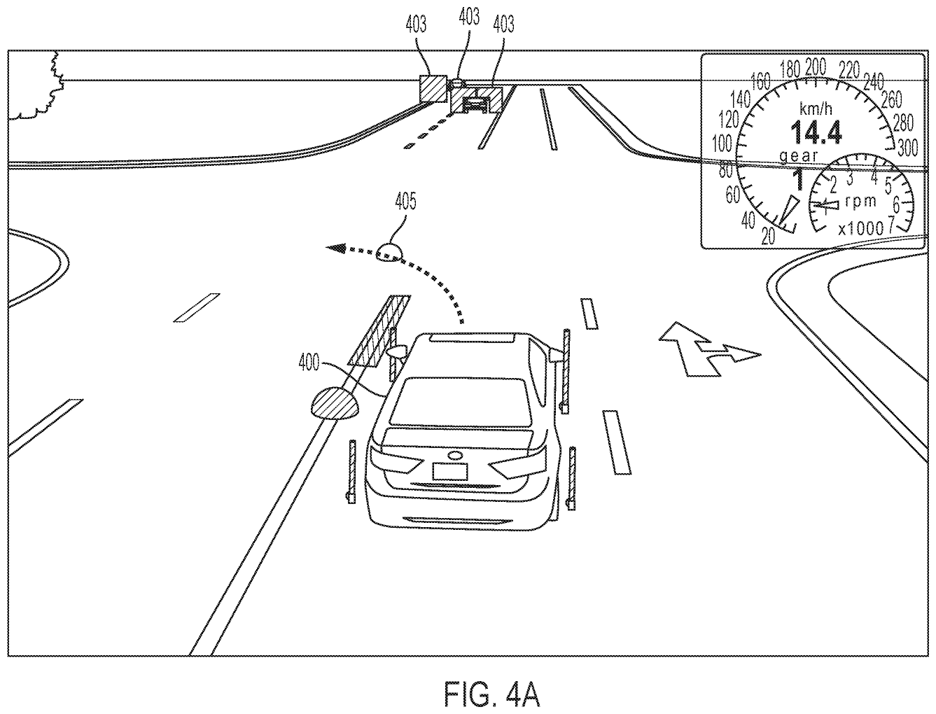

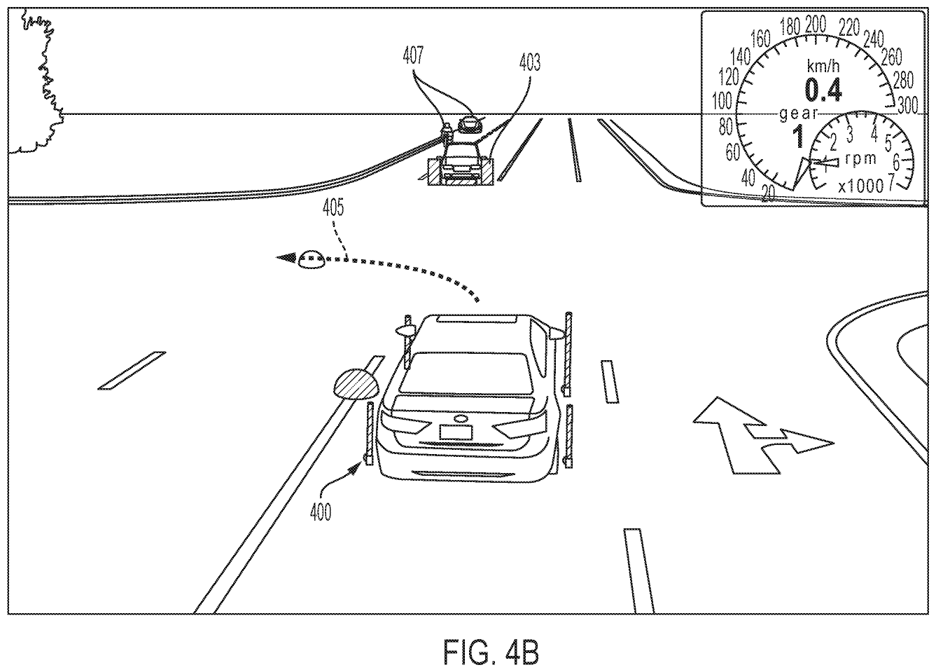

FIG. 4A illustrates a perspective view of an example of an autonomous vehicle with no sensor occlusion. While a vehicle may have a 360 degree FOV, when sensor occlusions occurs the sending signals/beams/rays are blocked, a full perception of the area around the host vehicle/ego vehicle 400 may be impossible to detect. In FIG. 4A, the a plurality of identified objects 403 may be identified as a motor bike and car that can be detected by the ego vehicle's sensors. The ego vehicle 400 may identify the objects and calculate a trajectory of those dynamic objects utilizing the sensor data (e.g. proximity data) and software applications. As shown in the upper right of FIG. 4A, the ego vehicle 400 may also monitor the vehicle speed, transmission gear, and an engine's RPM (revolutions per minute).

The ego vehicle 400 may also have a planned maneuver 405. The planned maneuver 405 may be, for example, a left hand turns at an intersection as described in FIG. 4A. The planned maneuver 405 may consider the vehicle's surrounding environment, including the detected objects 403. Additionally, the ego vehicle 400 may utilize other environmental features picked up by the sensors. For example, the host vehicle 400 may utilize a camera to identify lane markers to work in conjunction with a lane keep assist (LKA) feature.

FIG. 4B illustrates a perspective view of an example of an autonomous vehicle with sensor occlusion. The ego vehicle 400 may be the same as that shown in FIG. 4A but in a different time frame from before. For example, the host vehicle 400 may be beginning to maneuver a left turn as the oncoming traffic approaches. The two moving objects may be identified as a motor bike and car that were previously identifiable (e.g. in FIG. 4A) are now blocked. The blocked objects 407 may be blocked by the identified object 403. When the host vehicle 400 identifies that one or more blocked objects 407 may exist based on the application discussed above, the host vehicle may adjust the planned maneuvering 405. For example, the vehicle may either adjust the maneuvering, cancel the maneuvering, delay the maneuvering, etc. In another example, the host vehicle 400 may change its position to identify the blocked objects 407 and then adjust the maneuvering appropriately.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A driving system for a first vehicle, comprising:
a first and second sensor configured to obtain proximity data for one or more vehicles proximate the first vehicle; and
a processor in communication with the first and second sensors and programmed to perform the following functions:
(i) identifying a plurality of vehicles in a first field-of-view instance based on the proximity data, wherein the plurality of vehicles in the first field-of-view has a trajectory to approach a second field-of-view instance based on the proximity data;
(ii) counting a number of the plurality of vehicles in the first field-of-view compared to the second field-of-view; and
(iii) adjusting a vehicle maneuver in response to one of the plurality of vehicles being absent from the second field-of-view instance.

2. The driving system of claim 1, wherein the adjustment to the vehicle maneuver includes delaying the vehicle maneuver for a threshold time period.

3. The driving system of claim 1, wherein the adjusting function includes canceling the vehicle maneuver.

4. The driving system of claim 1, wherein the adjusting function includes executing the vehicle maneuver prior to one of the plurality of vehicles enter an area-of-intersection defined by utilizing at least overlapping trajectories of the one or more identified vehicle and the first vehicle.

5. The driving system of claim 1, wherein the adjusting function includes executing the vehicle maneuver after one of the plurality of vehicles enter an area-of-intersection defined by utilizing at least overlapping trajectories of the one or more identified vehicle and the first vehicle.

6. The driving system of claim 1, wherein the first and second sensor are LIDAR sensors, radar sensors, or camera sensors.

7. The driving system of claim 1, wherein the first vehicle includes a 360-degree field-of-view utilizing at least the first and second sensor.

8. The driving system of claim 1, wherein the adjusting function includes moving a position of the first vehicle until a number of identified vehicles proximate the first vehicle at the first field-of-view is equal to a number of identified vehicles proximate the first vehicle at the second field-of-view.

9. The driving system of claim 7, wherein the first vehicle is a fully autonomous vehicle configured to not driving allow operation of the vehicle by a driver.

10. The driving system of claim 1, wherein the first vehicle is a semi-autonomous vehicle configured to allow driving operation of the vehicle by a driver.

11. A driving system for a first vehicle, comprising:
one or more sensors configured to obtain proximity data for one or more vehicles proximate the first vehicle; and
a processor in communication with the one or more sensors and programmed to:
(i) identify, using the proximity data, two or more vehicles approaching an area-of-intersection defined by at least a trajectory of the first vehicle and trajectory of the two or more vehicles, wherein the trajectory of the first vehicle and trajectory of at least one of the two or more vehicles intersect in the area-of-intersection;
(ii) compare a number of identified vehicles that enter the area-of-intersection to the number of identified vehicles that exit the area-of-intersection; and
(iii) adjust a driver assistance function in response to the comparison identifying less identified vehicles that exit the area-of-intersection than enter the area-of-intersection.

12. The driving system of claim 11, wherein the processor is further programmed to identify a blocked vehicle in response to the comparison identifying less identified vehicles that exit the area-of-intersection.

13. The driving system of claim 11, wherein the processor is further programmed to identify a trajectory of the one or more vehicles proximate the first vehicle.

14. The driving system of claim 11, wherein the adjustment to the driver assistance function includes delaying a vehicle maneuver for a threshold time period.

15. The driving system of claim 14, the threshold time period is determined by identifying a time that the one or more vehicles proximate the first vehicle exits the area-of-intersection.

16. The driving system of claim 1, wherein the adjustment to the driver assistance function includes cancelling a vehicle maneuver.

17. The driving system of claim 1, wherein the adjustment to the driver assistance function includes executing a vehicle maneuver prior to the one or more vehicles proximate the first vehicle enters the area-of-intersection.

18. The driving system of claim 1, wherein the adjustment to the driver assistance function includes executing a vehicle maneuver to move a position of the first vehicle until the number of identified vehicles proximate the first vehicle at a first instance is equal to the number of identified vehicles proximate the first vehicle at at a second instance.

19. A method implemented in an autonomous vehicle, comprising:
obtaining proximity data for one or more vehicles proximate the autonomous vehicle utilizing a first and second sensor;
identifying a plurality of vehicles in a first field-of-view of a first sensor utilizing the proximity data, wherein the plurality of vehicles in the first field-of-view have a trajectory to enter a second field-of-view of the second sensor;
determining that one of the plurality of vehicles did not enter the second field-of-view in response to counting the plurality of vehicles that enter the first field-of-view compared to the second field-of-view;
maneuvering the autonomous vehicle in response to the determination, wherein the maneuvering includes adjusting a driver assistance function to modify the trajectory of the autonomous vehicle.

20. The method of claim 19, wherein the maneuvering of the autonomous vehicle includes moving a position of the autonomous vehicle to identify the one of the plurality of vehicles not entering the second field-of-view.
